(19) United States
(12) Patent Application Publication
(10) Pub. No.: US 2019/0113142 A1
(43) Pub. Date: Apr. 18, 2019

(54) VALVE ASSEMBLY

(71) Applicant: Tapmedic IP Limited, Huddersfield (GB)

(72) Inventor: David Newton, Wetherby (GB)

(21) Appl. No.: 16/093,931

(22) PCT Filed: Apr. 18, 2017
(86) PCT No.: PCT/GB2017/051060

§ 371 Date: Oct. 15, 2018

(30) Foreign Application Priority Data
Apr. 24, 2016 (GB) 1607111.0

(51) Int. Cl. F16K 5/04; F16K 31/44

(52) U.S. Cl. CPC F16K 5/0442; F16K 5/0492; F16K 31/44

(57) ABSTRACT

The present invention provides apparatus for coupling a valve element of a fluid control valve assembly to an actuator shaft (104) of the assembly, comprising an elongate body (106) having a first end region and a second end region, wherein the first end region comprises a first connecting portion for connecting to an actuator shaft of a fluid control valve assembly, and the second end region comprises a second connecting portion for connecting to a valve element of the assembly. A kit of parts and a method for selectively assembling a fluid control valve assembly is also provided.

The present invention relates to a valve assembly for controlling the flow of a fluid, and a kit of parts and a method for assembling such a valve assembly. In particular, but not exclusively, the present invention relates to a ceramic disc valve assembly, which is typically used for domestic or commercial liquid control applications, such as in taps, faucets, shower mixer and diverter valves, or the like.

A conventional tap/shower valve assembly typically includes a tap body having a spout, a ceramic disc cartridge having a ceramic disc valve arrangement and a shaft having a serrated upper end region, a handle located on the serrated shaft for selectively opening and closing the valve arrangement, a retaining screw for securing the handle to the shaft, and a screw cover which typically includes a reference to indicate if the tap is for selectively controlling the flow of hot or cold water. A conventional tap/shower valve assembly may alternatively utilise a valve member, known as a jumper, which is selectively moved in a vertical direction away from or towards a valve seat to open or close the valve respectively.

A conventional ceramic disc cartridge typically includes a hollow, cylindrical, open-ended, brass body defining an annular flange about midway along its length. A lower portion of the body below the flange includes radially opposed openings and a first screw thread for attaching to the tap body. An O-ring is located below the flange to seal the interface between the flange and the tap body when the cartridge is attached thereto. The cartridge body typically includes a nut region above and adjacent to the flange to allow a spanner or wrench to engage with and rotate the cartridge body to screw the same to the tap body. The upper portion of the cartridge body may also include a second screw thread above the nut portion for attaching a cover to the cartridge. The ceramic disc arrangement of the cartridge includes two ceramic disc parts; the first disc part has opposed triangular through openings and is fixed in relation to the cartridge body, whilst the second disc part is moveable relative to the first disc part and is sized to close the through openings when in a closed position and to open the through openings when in an open position. Each ceramic disc part has a particularly flat mating surface to allow the disc parts to engage exactly together whilst allowing rotation of the second part on the first disc part to selectively open and close the valve. The moveable second disc part is attached to a lower end of the shaft of the cartridge such that the shaft and second disc part are rotatable together in use. In an assembled state, the shaft extends from the upper opening of the cartridge body for the tap handle to attach to the serrated end of the shaft. The shaft may include one or more annular grooves for locating a respective O-ring to prevent water flows up past the shaft and out of the cartridge body. The shaft typically includes an annular groove for locating a circlip which abuts the upper end of the cartridge body and retains the shaft therein. The lower end of the cartridge body is closed off by an end cap which also retains the ceramic disc parts in the cartridge body and prevents the disc parts moving apart in use. The end cap has a central aperture for allowing water into the cartridge and through the ceramic disc valve when in an open state. Protrusions on the inside of the cartridge body typically limit rotation of the shaft to a quarter turn to define the open and closed valve positions.

Each ceramic disc cartridge is supplied in an assembled state and is configured for use with a specific type of tap, shower valve, or the like. For example, the cartridge body may be sized and configured to include a ½ inch or a ¾ inch lower screw thread for attaching to a correspondingly threaded tap or shower valve body. The cartridge body may or may not have an upper screw thread for receiving a cover depending on the type of tap and application the cartridge is to be used for. Furthermore, the length of the shaft is different for the type of tap and application the cartridge is to be used for. In addition, the number of serrations on the upper end of the shaft can vary depending on the configuration of handle to be attached thereto. Also the finish of the shaft may be stainless steel, chrome, brushed steel, or the like, depending on the application for the cartridge, and each cartridge has a specific direction of rotation to be used on the left or right side, i.e. hot or cold tap, of a bridge mixer tap for example.

Therefore, conventional ceramic disc cartridges are available in an almost infinite number of permutations of overall lengths, shaft serration counts, shaft serration heights, cartridge body sizes, cartridge body threads, valve opening directions, and finish, or the like. It is not commercially viable to store and transport the required stock to cater for all types of ceramic disc cartridge valve which means that when a valve requires replacement, most plumbing engineers recommend a new tap set or shower valve instead of carrying out a simple repair, i.e. replacement of the failed cartridge, due to the effort required to try and trace a replacement cartridge for that particular type of tap or valve. This leads to perfectly serviceable equipment being replaced instead of being repaired. This in turn ultimately results in unnecessary expense to the user and a significant amount of wasted materials and resources.

The above problems also apply to other conventional types of fluid control valve assembly, such as a vertically moveable jumper-style valve assembly, or the like, that includes a one-piece actuator shaft having a predetermined configuration, such as length, diameter, number/length of serrations, integral valve member, or the like, for a specific technical application.

It is an aim of certain embodiments of the present invention to provide a kit of parts for efficiently assembling a fluid control valve assembly to be used for a particular application, wherein the kit is efficient to store and transport and includes at least the essential components to keep associated costs of the kit to a minimum.

It is an aim of certain embodiments of the present invention to provide a kit of parts for efficiently maintaining an existing fluid control valve assembly in a timely, inexpensive and environmentally friendly manner.

It is an aim of certain embodiments of the present invention to provide a kit of parts which allows any one of a plurality of standard configurations of a fluid control valve assembly to be quickly and efficiently assembled for replacement of an existing valve assembly and thus to avoid undesirably replacing a complete tap set or shower valve for example.

It is an aim of certain embodiments of the present invention to provide a universal coupling member for coupling a valve member, such as a first ceramic disc part of a ceramic disc valve, with an actuator shaft of the valve assembly, wherein the valve member and/or the actuator shaft is respectively selected from a plurality of differently configured valve members and actuator shafts.

A first aspect of the present invention provides apparatus for coupling a valve element of a fluid control valve assembly to an actuator shaft of the assembly, comprising:
an elongate body having a first end region and a second end region, wherein the first end region comprises a first connecting portion for connecting to an actuator shaft of a fluid control valve assembly, and the second end region comprises a second connecting portion for connecting to a valve element of the assembly.

Optionally, the first connecting portion comprises at least one centrally located recess axially disposed in the first end region for receiving an end region of the actuator shaft.

Optionally, the recess comprises a non-circular cross section corresponding to a cross section of the end region of the actuator shaft.

Optionally, the non-circular cross section is substantially heptagonal.

Optionally, the second connecting portion comprises at least one recess or projection for connection with a correspondingly shaped projection or recess of the valve element.

Optionally, the at least one projection comprises a centrally located and transversely oriented elongate rib for receipt in a correspondingly shaped recess of the valve element.

A second aspect of the present invention provides a kit of parts for selectively assembling a fluid control valve assembly, comprising:
at least one elongate and hollow valve body having a first open end region and a second open end region;
at least one apparatus according to the first aspect of the present invention;
at least one actuator shaft for connecting at a first end to the first end region of the apparatus; and
at least one valve element for connecting to the second end region of the apparatus.

Optionally, the at least one valve element comprises a rotational ceramic disc valve element or a translational jumper valve element.

Optionally, the at least one valve element comprises a first ceramic disc valve element and the kit further comprises:
a second ceramic disc valve element for engaging with the first ceramic disc valve element; and
an end cap for urging the second ceramic disc valve element against the first ceramic disc valve element and securely locating the ceramic disc elements in the valve body, wherein the end cap comprises a centrally located opening.

Optionally, the valve body comprises an outwardly extending annular flange disposed between the first and second open end regions, a first screw thread located on an outer surface between the second open end region and the annular flange, and at least a first pair of radially opposed and outwardly facing substantially flat surfaces located between the first open end region and the annular flange.

Optionally, the kit further comprises:
at least one adaptor for locating on the annular flange and proximal the first open end region of the valve body, the adaptor comprising a second screw thread on an outer surface thereof and a centrally located aperture having at least a second pair of opposed flat surfaces corresponding to the first pair of opposed flat surfaces of the valve body.

Optionally, the kit further comprises at least one O-ring, washer, circlip, grub screw, and/or adhesive.

Optionally, the at least one valve body comprises a plurality of differently configured valve bodies.

Optionally, a first screw thread of a one of the plurality of valve bodies comprises a ½ inch screw thread, and a first screw thread of a further one of the plurality of valve bodies comprises a ¾ inch screw thread.

Optionally, the at least one actuator shaft comprises a plurality of differently configured actuator shafts.

Optionally, the plurality of actuator shafts comprises at least one first shaft having about around 18 serrations circumferentially disposed around a second end of the at least one first shaft, at least one second shaft having about around 20 serrations circumferentially disposed around a second end of the at least one second shaft, at least one third shaft having about around 24 serrations circumferentially disposed around a second end of the at least one third shaft, and at least one fourth shaft having about around 28 serrations circumferentially disposed around a second end of the at least one fourth shaft.

Optionally, each of the at least one first, second, third and fourth shafts comprises a plurality of respective shafts having a length of about around 30 to 120 mm, wherein each of the respective shafts has a different length.

Optionally, the kit further comprises a container for locating each of the parts in when in an unassembled state.

A third aspect of the present invention provides a fluid control valve assembly comprising:
at least one elongate and hollow valve body having a first open end region and a second open end region;
at least one apparatus according to the first aspect of the present invention located in the body;
at least one actuator shaft connected at a first end to the first end region of the apparatus; and
least one valve element connected to the second end region of the apparatus.

A fourth aspect of the present invention provides a method of assembling a fluid control valve assembly, comprising:
connecting a first end region of an actuator shaft to a first end region of apparatus according to the first aspect of the present invention via the first connecting portion of the apparatus; and
connecting a valve element to the second end region of the apparatus via the second connecting portion of the apparatus.

Optionally, the method further comprises:
prior to connecting the actuator shaft to the apparatus, slidably locating the apparatus in an elongate and hollow valve body having a first open end region and a second open end region.

Optionally, the valve body comprises an annular flange disposed between the first and second open end regions, a first screw thread located on an outer surface thereof between the second open end region and the annular flange, and at least a first pair of radially opposed and outwardly facing substantially flat surfaces located between the first open end region and the annular flange, such that a second end region of the actuator shaft extends beyond the first open end region of the valve body when connected with the apparatus.

Optionally, the valve element comprises a first ceramic disc valve element, and the method further comprises:
locating a second ceramic disc valve element in abutment with the first ceramic disc valve element via the second open end region of the valve body and such that the second ceramic disc valve element is rotationally constrained with respect to the valve body; and
locating an end cap on the second open end region of the valve body, the end cap comprising a centrally located opening.

Optionally, the method further comprises selecting the actuator shaft from a plurality of differently configured actuator shafts.

Optionally, the plurality of actuator shafts at least one first shaft having about around 18 serrations circumferentially disposed around a second end of the at least one first shaft, at least one second shaft having about around 20 serrations circumferentially disposed around a second end of the at least one second shaft, at least one third shaft having about around 24 serrations circumferentially disposed around a second end of the at least one third shaft, and at least one fourth shaft having about around 28 serrations circumferentially disposed around a second end of the at least one fourth shaft.

Optionally, each of the at least one first, second, third and fourth shafts comprises a plurality of respective shafts having a length of about around 30 to 120 mm, wherein each of the respective shafts has a different length.

Optionally, the method further comprises selecting the valve body from a plurality of differently configured valve bodies.

Optionally, a first screw thread of a one of the plurality of valve bodies comprises a ½ inch screw thread, and a first screw thread of a further one of the plurality of valve bodies comprises a ¾ inch screw thread.

A fifth aspect of the present invention provides apparatus as substantially herein described with reference to one or more of the accompanying drawings.

A sixth aspect of the present invention provides a kit of parts as substantially herein described with reference to one or more of the accompanying drawings.

A seventh aspect of the present invention provides an assembly as substantially herein described with reference to one or more of the accompanying drawings.

An eighth aspect of the present invention provides a method as substantially herein described with reference to one or more of the accompanying drawings.

### DESCRIPTION OF THE DRAWINGS

Certain embodiments of the present invention will now be described with reference to the accompanying drawings in which:

FIG. 1 illustrates an exploded assembly including the key components of a ceramic disc cartridge valve according to certain embodiments of the present invention;

FIG. 2 illustrates different views of an embodiment of the cartridge body of the exploded assembly of FIG. 1;

FIG. 3 illustrates different views of an embodiment of the coupling member of the exploded assembly of FIG. 1; and

FIG. 4 illustrates a kit of parts for selectively assembling a ceramic disc cartridge valve having a desired configuration in accordance with certain embodiments of the present invention.

### DETAILED DESCRIPTION

Although a ceramic disc cartridge valve assembly for controlling a tap/shower has been used hereinbelow to describe certain embodiments of the present invention, it will be understood that the terms ‘fluid control valve assembly’ include other types of fluid control valve assembly, such as a jumper-style valve assembly, a faucet valve, a diverter valve, a shower mixer valve, or the like, which includes a valve member movable between open and closed positions by an actuator shaft.

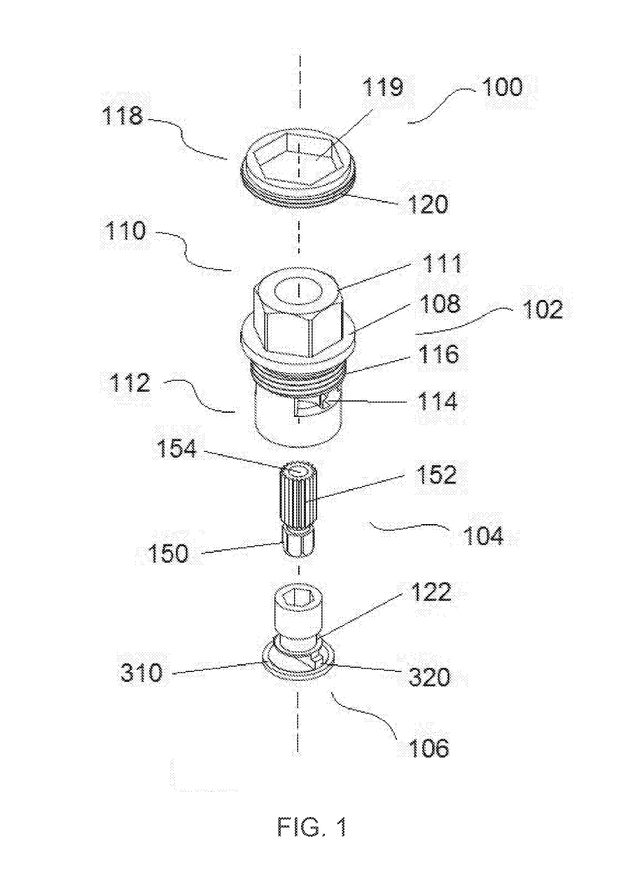

As shown in FIG. 1, a ceramic disc cartridge valve assembly 100 according to certain embodiments of the present invention includes a cartridge body 102, an actuator shaft 104 and a universal coupler 106 for coupling the shaft 104 to a first ceramic disc part (not shown).

The cartridge body 102 is substantially hollow and cylindrical and has upper and lower open ends. An annular flange 108 is located about midway along the elongate body and between the two open end regions 110, 112. The annular flange provides a lower abutment surface for abutting a tap body when in situ in a tap assembly for example. Aptly, an O-ring is located underneath the annular flange to provide a seal between the annular flange and a tap body. The upper end region 110 of the cartridge body 102 has a substantially hexagonal cross section 111 which resembles a nut for a suitable tool, such as a spanner or wrench, to rotatably drive the cartridge valve assembly 100 into a tap or shower valve body, or the like. Instead of a hexagonal cross section, the upper portion may comprise at least two radially opposed flat surface to allow a suitable tool to engage and drive the cartridge body. The lower end region 112 of the cartridge body 102 below the annular flange 108 includes at least two radially opposed openings 114 for allowing a fluid, such as domestic hot or cold water, to flow out of the cartridge and towards a tap/shower outlet when the ceramic disc valve is in an open state. The opposed openings 114 are illustrated as substantially rectangular slots but could be one or more openings and/or could be any suitable shape and size, such as circular, oval, or the like. Between the openings 114 and the annular flange 108 is disposed a first screw thread 116 for securing the cartridge body 102 to a tap/shower valve body. The first screw thread is typically a ¾ inch or a ½ inch screw thread depending on the configuration of the tap/shower valve body, but other sizes of screw thread are envisaged.

An optional adaptor 118 which includes a hexagonal central through opening 119 and a second screw thread 120 may be provided for slidably fitting on the nut-like end region to provide the second screw thread 120 on the upper end region 110 of the cartridge body 100 for receiving a correspondingly threaded cover member (not shown) which may be used for aesthetic purposes to conceal the cartridge and shaft in use. The optional adaptor 118 can be adhered to the upper surface of the annular flange 108 by suitable adhesive, such as cyanoacrylate or the like.

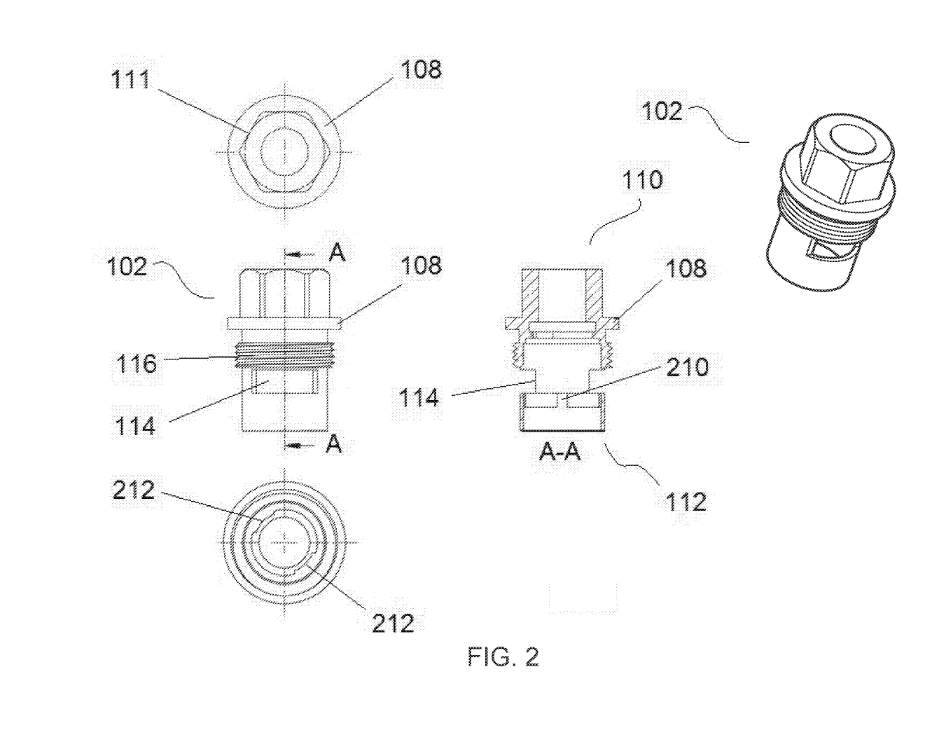

As shown in FIG. 2, the lower portion 112 of the cartridge body 102 includes two opposed elongate recesses 210 in the form of slots extending upwardly from the lower end of the cartridge body. Each of these slots 210 is configured such that either opposed two of the slots can slidably receive a pair of correspondingly shaped and opposed projections/lugs of a conventional second ceramic disc part (not shown) such that the second ceramic disc part is rotationally constrained when fitted in the assembled cartridge valve assembly 100.

Alternatively, the body 102 may include four equally and circumferentially spaced elongate recesses to allow the second ceramic disc part to be selectively fitted in the cartridge body 102 in a number of different rotational orientations. As described above, the second ceramic disc part of a conventional ceramic disc cartridge typically includes a pair of opposed triangular openings to allow water up and through the ceramic disc valve when the upper (first) ceramic disc part is in an open position with respect to the lower (second) ceramic disc part.

The cartridge body 102 further includes a pair of opposed and inwardly extending projections 212 for abutting corresponding portions 320 of the actuator shaft 104 (described further below) and which are sized to limit rotational movement of the shaft, and thus the first ceramic disc part, with respect to the cartridge body 102 to a ¼ turn between open and closed positions. Depending on the rotational orientation of the second ceramic disc part and thus the opposed openings therein with respect to the projections 212, the cartridge assembly 100 can simply and quickly be selectively configured to be used in a ‘turn clockwise or anticlockwise to open’, i.e. right or left hand, or hot or cold, tap/shower valve assembly. When the actuator shaft 104, coupling member 106, and ceramic disc parts are fitted in the cartridge body 102, a sealed end cap (not shown) is connected to the lower end of the cartridge body by snap fit, interference fit, screw thread, or the like, to urge the second ceramic disc part upwardly and against the first ceramic disc part to ensure the same remain engaged together in use. The end cap includes a centrally located opening to allow water into the valve assembly. Suitable dimensions for a cartridge body according to certain embodiments of the present invention are shown in FIG. 2.

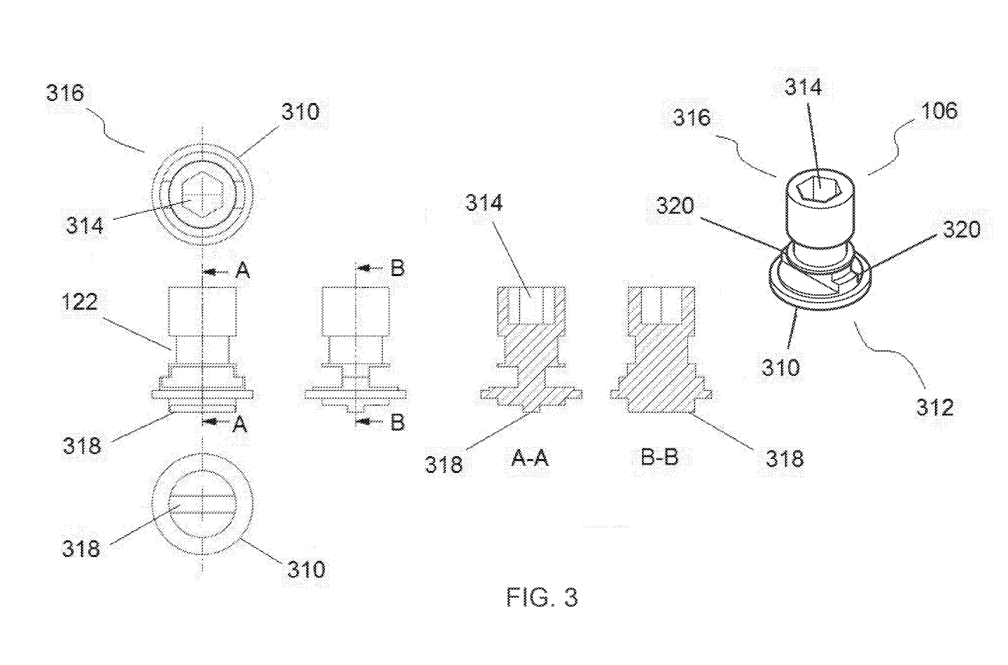

As shown in FIGS. 1 and 3, the coupling member 106 is substantially cylindrical and elongate and has an annular flange 310 at a lower end region 312 and a centrally located bore 314 in an upper end region 316. The bore 316 has a substantially hexagonal cross section (as shown in FIG. 1) or aptly a substantially heptagonal cross section (as shown in FIG. 3). A substantially heptagonal cross section provides a greater tolerance for slight rotational adjustment to an actuator shaft, and in turn a handle, particularly in the form of a lever, attached to the shaft before the shaft is securely connected to the coupling member 106. For example, the handle may be slightly misaligned with the tap/shower valve body and/or another handle attached to the tap/shower body when in an open or closed position. The shaft may be removed from the coupling member 106 and slightly rotated by at least one flat surface of the bore before being reinserted and securely connected therewith.

A transverse rib 318 is disposed below the annular flange 310 and extends at least partially across the annular flange 310 and through a longitudinal axis of the coupling member 106. This rib 318 is configured to be received in a correspondingly shaped slotted recess of the first ceramic disc part for connecting the first ceramic disc part to the coupling member. The underside of the annular flange 310 engages with an upper surface of a conventional first ceramic disc part to locate and support the same in use. Other suitable connection arrangements can be envisaged such as the first ceramic disc part having a pair of spaced apart recesses for corresponding projections of a pronged end region of the coupling member to engage with.

As shown in FIG. 3, the coupling member 106 includes a pair of opposed projections 320 for abutment with the corresponding abutment surfaces within the cartridge body 102 as described above for limiting rotational movement of the coupling member 106 with respect to the cartridge body 102 when driven by the actuator shaft 104. The coupling member 106 further includes an annular groove 122 for receiving an O-ring for providing a seal between the coupling member 106 and the cartridge body 102 when assembled together. The O-ring prevents water passing up between the coupling member 106 and the shaft 104 and undesirably out of the valve assembly, particularly when the valve is in a closed state. Two or more annular grooves may alternatively be provided if additional sealing is required. The coupling member 104 may also include an annular groove for receiving a circlip to axially constrain the coupling member with respect to the cartridge body when fitted therein.

As illustrated in FIG. 1, the substantially heptagonal bore 314 of the coupling member 106 is configured to slidably receive a correspondingly shaped lower end region 150 of the actuator shaft 104 such that the shaft is rotationally constrained when coupled to the coupling member. The bore 314 and lower end region 150 may however be any suitable shape, such as square, triangular, oval, serrated, splined, toothed, or the like, to couple the shaft with the coupling member whilst preventing rotational movement therebetween, particularly when the actuator shaft 104 is being rotated to drive the coupling member 106 and, in turn, the first ceramic disc part of the valve assembly 100. Again, a suitable adhesive may be used to securely attach the shaft 104 to the coupling member 106. For relatively light duty applications, a suitable snap, friction or interference fit between the shaft and the coupling member may be sufficient to prevent rotational movement therebetween when in use. Other forms of connection may be utilised such as a pin, a reverse screw thread with respect to an actuating direction of the shaft to open the valve member, or the like, and of course the bore of the coupling member 106 may alternatively be a form of projection for receipt in a correspondingly shaped recess in the lower end of the actuator shaft 104. An upper end portion 152 of the actuator shaft 104 is serrated, splined or toothed to receive a correspondingly serrated, splined or toothed tap or shower valve handle or lever. A threaded hole 154 is centrally located in the upper end region 152 for receiving a correspondingly threaded screw for attaching the handle/lever to the shaft. In accordance with certain embodiments of the present invention, the shaft 104 may be one of a plurality of different lengths and include a desired number and length of splines/teeth for connection with a correspondingly configured tap/shower handle or lever.

FIG. 2 shows a cartridge body 102 having a ¾ inch diameter outer screw thread which is about around 5 mm in length. The lower body portion 112 below the annular flange 108 has a length of about around 18 mm and an outer diameter of about around 18 mm. The upper body portion 110 above the annular flange 108 has a length of about around 10 mm and a width across opposed flat surfaces of the nut portion of about around 17 mm. The flange 108 has an outer diameter of about around 24 mm and a thickness of about around 2.5 mm. The opening in the upper end 110 of the body has a diameter of about around 10 mm and the opening in the lower end 112 of the body has a diameter of about around 15 mm. The slotted openings 114 are about around 10 mm wide and about around 5 mm high, and the elongate recesses 210 are about around 2 mm wide and about around 5 mm high.

The coupling member 106 shown in FIG. 3 has a length of about around 15-25 mm. The upper portion 316 has a diameter of about around 10 mm and the annular flange 310 has a diameter of about around 15 mm and a thickness of about around 1 mm. The elongate rib 318 has a length of about around 10 mm, a height of about around 2 mm and a width of about around 2.5 mm. The annular groove 122 has a diameter of about around 7 mm and a height of about around 4 mm, but any suitable size of groove may be suitable to receive and locate a desirably sized O-ring. The bore 314 is about around 7 mm deep and a width between opposed flat surfaces of about around 6 mm. The upper portion of the coupling member 106 above the annular groove 122 has a length of about around 10 mm.

The cartridge body 102, shaft 104, coupling member 106 and optional adaptor 118 are preferably made from brass, however any suitable material may be used for one or all of these parts, such as stainless steel, aluminum, polymer, or the like. The shaft for example may include an outer finish or texture, such as a silver, chrome, gold, bronze, or brushed steel, or the like.

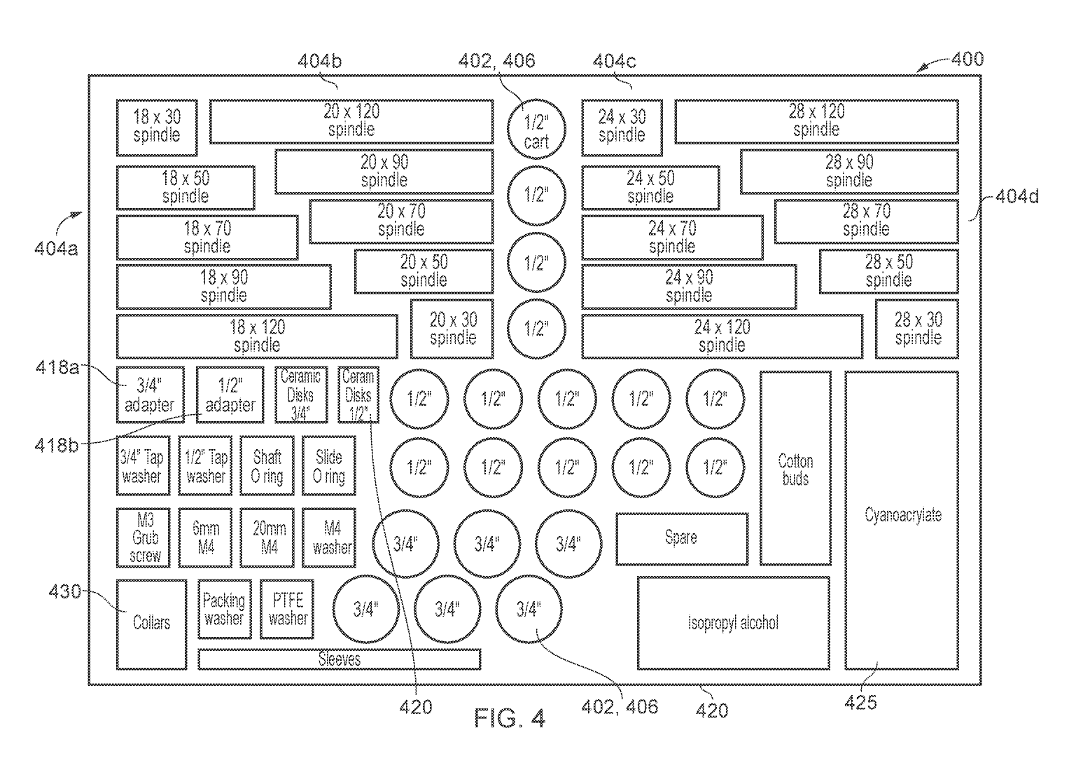

As shown in FIG. 4, a kit of parts 400 is provided in accordance with certain embodiments of the present invention. The kit 400 includes a plurality of cartridge bodies 402 which include a ½ inch or a ¾ inch screw thread (and/or other desirable thread sizes) below the annular flange 108 and are diametrically sized accordingly. Thus, a ½ inch or ¾ inch cartridge body 402 may be selected from the kit for fitting in a correspondingly configured tap or shower valve body. The kit further includes four groups of actuator shafts 404a-404d wherein each group includes five shafts having different lengths but the same number of splines/teeth. The different lengths of the shafts in each group are 30 mm, 50 mm, 70 mm, 90 mm, and 120 mm and the different number of splines are 18, 20, 24 and 28. These are standard lengths and spline/teeth numbers but any variety and combinations of shaft length, diameter, spline length and number can be envisaged in accordance with certain embodiments of the present invention to suit any particular technical application for the cartridge assembly. Furthermore, if the shaft of an existing cartridge to be replaced is particularly bespoke and has a different length of spline for example to any of the shafts in the kit, a shaft having a length which is close to the existing shaft may be selected and then cut to size using a suitable tool such as a hacksaw. The kit 400 further includes one or more ¾ inch optional adaptors 418a and one or more ½ inch optional adaptors 418b. The kit 400 further includes a plurality of ceramic disc parts 420 for use in a selected ½ inch or ¾ inch cartridge body. The kit further includes a plurality of universal coupling members 406 for use with a selected pair of the ceramic disc parts 420, a selected one of the shafts 404a-d, and a selected one of the cartridge bodies 402. The coupling members 406 may be provided separate to the cartridge bodies 402 or may be provided pre-fitted in each of the differently configured cartridge bodies 402. A plurality of end caps/collars 430 are also provided for closing the lower end of the selected cartridge body when the selected ceramic disc parts, coupling member and shaft are located therein to complete the cartridge assembly. The kit 400 further includes one or more ½ inch and ¾ inch tap washers, one or more O-rings for locating on the selected shaft, one or more O-rings for locating on the universal coupling member, a plurality of differently sized grub screws and washers, cyanoacrylate adhesive for securely attaching the selected shaft into the universal coupling member and the selected optional adaptor onto the selected cartridge body. Some cotton buds and isopropyl alcohol may also be provided for cleaning parts of the valve assembly such as the engaging surface of the selected ceramic disc parts before assembly.

The kit of parts 400 may be contained in a suitable container 420 including a lid (not shown) and a plurality of recesses (e.g. 425) which are correspondingly shaped with a profile of a respective one of the parts locatable in each recess. Each recess/part may include an identifier such as an identification number, barcode, or the like, to allow a user to input into an application on a mobile device which parts he/she has selectively used to assembly a replacement cartridge. The application may record and store the parts used over time and/or automatically place an order for a new one of the parts so that the kit of parts is always complete. The new parts may be automatically delivered to the user's home or place of work using user details input by the user when originally registering to use the application. A user's account may include bank details to allow for automatic payment of any new parts. The information collected via the application may be used to determine which parts are used more than others and thus allow a manufacture to make more of one particular part than another. The parts used may also indicate which configuration of cartridge assemblies are most popular and thus allow tap/shower valve manufacturers to act accordingly.

Therefore, in accordance with the certain embodiments of the present invention, the kit 400 allows a competent homeowner or plumbing engineer to simply and efficiently replace a failed ceramic disc cartridge without having to unnecessarily replace the entire tap/shower valve assembly and without having to store and transport a vast array of differently sized and configured conventional ceramic disc cartridges. Once the size and configuration of the existing cartridge to be replaced has been determined, a replacement cartridge can simply and quickly be assembled by selecting the relevant components from the kit 400 and then fitting the assembled cartridge in the existing tap/shower body.

Certain embodiments of the present invention therefore provide a universal coupling member 106 for coupling a selected one of a plurality of differently configured actuator shafts to a selected valve member to assemble a fluid control valve assembly, such as a ceramic disc cartridge, having the same configuration as an existing valve assembly to be replaced. This significantly reduces the cost and amount of stock a plumbing engineer is otherwise required to outlay, store and transport. Furthermore, a kit of parts 400 allows the plumbing engineer to simply and efficiently assemble a fluid control valve assembly, such as a ceramic disc cartridge, on site using a minimum amount of differently configured components to replace an existing valve assembly without having to replace the entire tap/shower valve which is otherwise unnecessarily costly to the customer and environmentally unfriendly in view of the excess parts and material being disposed of.

1-28. (canceled)

29. Apparatus for coupling a valve element of a fluid control valve assembly to an actuator shaft of the assembly, the apparatus comprising:
an elongate body having a first end region and a second end region,
wherein:
the first end region comprises a first connecting portion for connecting to an actuator shaft of a fluid control valve assembly, and
the second end region comprises a second connecting portion for connecting to a valve element of the assembly.

30. The apparatus as claimed in claim 29, wherein the first connecting portion comprises at least one centrally located recess axially disposed in the first end region for receiving an end region of the actuator shaft.

31. The apparatus as claimed in claim 30, wherein the recess comprises a non-circular cross section corresponding to a cross section of the end region of the actuator shaft.

32. The apparatus as claimed in claim 31, wherein the non-circular cross section is substantially heptagonal.

33. The apparatus as claimed in claim 29, wherein the second connecting portion comprises at least one recess or projection for connection with a correspondingly shaped projection or recess of the valve element.

34. The apparatus as claimed in claim 33, wherein the at least one projection comprises a centrally located and transversely oriented elongate rib for receipt in a correspondingly shaped recess of the valve element.

35. A kit of parts for selectively assembling a fluid control valve assembly, comprising:
at least one elongate and hollow valve body having a first open end region and a second open end region;
at least one apparatus as claimed in claim 29;
at least one actuator shaft for connecting at a first end to the first end region of the apparatus; and
at least one valve element for connecting to the second end region of the apparatus.

36. The kit of parts as claimed in claim 35, wherein the at least one valve element comprises a rotational ceramic disc valve element or a translational jumper valve element.

37. The kit of parts as claimed in claim 36, wherein the at least one valve element comprises a first ceramic disc valve element and the kit further comprises:
a second ceramic disc valve element for engaging with the first ceramic disc valve element; and
an end cap for urging the second ceramic disc valve element against the first ceramic disc valve element and securely locating the ceramic disc elements in the valve body, wherein the end cap comprises a centrally located opening.

38. The kit as claimed in claim 35, further comprising at least one adaptor for locating on the annular flange and proximal the first open end region of the valve body, the adaptor comprising a second screw thread on an outer surface thereof and a centrally located aperture having at least a second pair of opposed flat surfaces corresponding to the first pair of opposed flat surfaces of the valve body.

39. The kit as claimed in claim 35, wherein the at least one valve body comprises a plurality of differently configured valve bodies.

40. The kit as claimed in claim 35, wherein the at least one actuator shaft comprises a plurality of differently configured actuator shafts.

41. A fluid control valve assembly comprising:
at least one elongate and hollow valve body having a first open end region and a second open end region;
at least one apparatus as claimed in claim 29 located in the body;
at least one actuator shaft connected at a first end to the first end region of the apparatus; and
at least one valve element connected to the second end region of the apparatus.

42. A method of assembling a fluid control valve assembly, comprising the steps of:
connecting a first end region of an actuator shaft to a first end region of apparatus as claimed in claim 29 via the first connecting portion of the apparatus; and
connecting a valve element to the second end region of the apparatus via the second connecting portion of the apparatus.

43. The method as claimed in claim 42, further comprising, prior to connecting the actuator shaft to the apparatus, slidably locating the apparatus in an elongate and hollow valve body having a first open end region and a second open end region.

44. The method as claimed in claim 43, wherein:
the valve element comprises a first ceramic disc valve element, and
the method further comprises:
locating a second ceramic disc valve element in abutment with the first ceramic disc valve element via the second open end region of the valve body and such that the second ceramic disc valve element is rotationally constrained with respect to the valve body; and
locating an end cap on the second open end region of the valve body, the end cap comprising a centrally located opening.

45. The method as claimed in claim 42, further comprising the step of selecting the actuator shaft from a plurality of differently configured actuator shafts.

46. The method as claimed in claim 42, further comprising the step of selecting the valve body from a plurality of differently configured valve bodies.
